(19) United States
(12) Patent Application Publication
(10) Pub. No.: US 2015/0239007 A1
(43) Pub. Date: Aug. 27, 2015

(54) Chemical Stick Finishing Method and Apparatus

(71) Applicant: Gary S. Selwyn, Albuquerque, NM (US)

(72) Inventor: Gary S. Selwyn, Albuquerque, NM (US)

(21) Appl. No.: 14/423,363

(22) PCT Filed: Aug. 23, 2013
(86) PCT No.: PCT/US13/56442

§ 371 Date: Feb. 23, 2015

Related U.S. Application Data
(60) Provisional application No. 61/692,577, filed on Aug. 23, 2012.

(51) Int. Cl. B05D 1/28; D06M 10/02; D06M 10/00; B05D 3/06; D06M 15/277; D06M 15/263; B05D 3/14; D06P 5/24; D06M 13/513

(52) U.S. Cl. CPC B05D 1/283; D06P 5/007; D06M 10/025; D06M 10/003; D06M 13/513; D06M 15/277; D06M 15/263; B05D 3/147; B05D 3/068; B05D 3/067; D06M 2200/12; D06M 2200/11

(57) ABSTRACT

Substrates such as fabrics are treated in an apparatus that includes a chemical transfer apparatus and a transport means which conducts the substrate past the chemical transfer apparatus. The chemical transfer apparatus applies a solid chemical treatment mixture to the substrate continuously as the substrate is transported past the chemical transfer apparatus. The chemical treatment mixture includes a monomer that is cured by free radical polymerization. The applied chemical treatment mixture is then cured on the substrate by free radical polymerization. This invention provides a dry alternative to conventional wet coating methods, and avoids many of the problems associated with wet coating methods.

The present invention relates generally to a method and apparatus for applying a chemical mixture to a fibrous substrate.

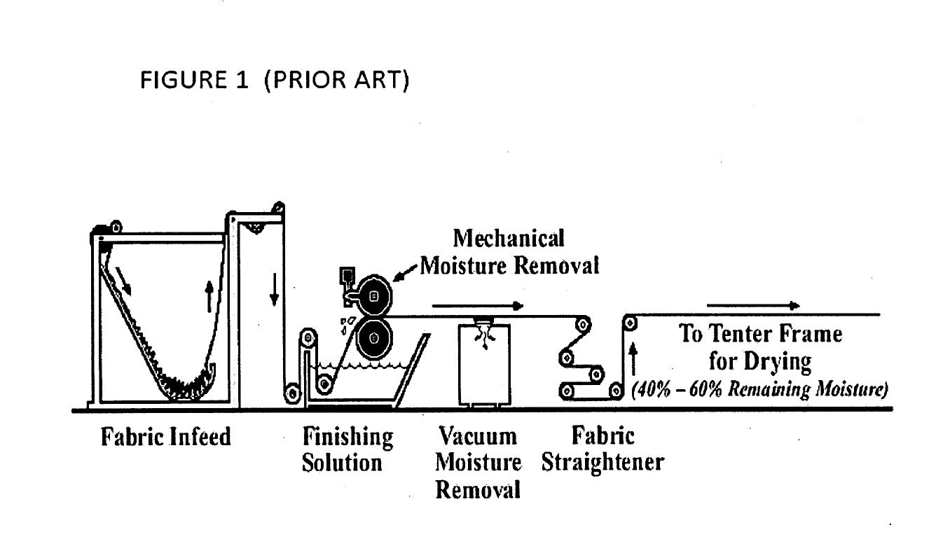

Textile and nonwoven manufacturing includes various chemical treatment operations ranging from the infusion of a sizing compound to aid in high speed weaving, to dyeing and other finishing steps used to impart specific attributes to a finished fabric or nonwoven. Conventional fabric finishing is often done using a “pad and cure” method that involves pulling a length of fabric through an aqueous chemical bath, squeezing or vacuuming out the excess liquid and then drying or curing the wet fabric in a long, air-operated oven called a “tenter frame.” FIG. 1 shows a labeled schematic diagram of a typical “pad and cure” process used for finishing textiles. A finishing solution containing multiple ingredients is mixed in a chemical bath, in which the fabric is immersed and absorbs some of the chemical solution. Excess water is first removed mechanically then the wet fabric is heated and dried in a tenter frame oven, which holds the fabric taut to help avoid shrinkage during this “curing” operation. Despite the effort at shrinkage control, about 3-8% of shrinkage-prone fabrics are “lost” due to actual shrinkage during this step. That represents an actual financial loss to textile manufacturers. The fabric leaving the water removal station(s) still has much water content which must be boiled away for finishing. This adds significant energy cost to the treatment process, in addition to the consumption and waste of a large amount of water.

Because of the large equipment and energy costs associated with this process, it is desirable that the fabric be treated only once in this way. For that reason, various chemicals often are mixed together in the finishing bath. These chemicals might include, for example, softeners, dyes, surfactants, wetting agents, polymers, oligomers, emulsifiers, buffers and other chemicals that are used to obtain a “conventional” finishing treatment for textiles. A major problem results due to the limited compatibility of these water-based chemicals: unwanted precipitates, cross-reactions, and component “exhaustion” are commonplace, especially during prolonged use. Monomers are not generally added to a wet processing bath because of their high chemical reactivity. Some potentially valuable, but insoluble finishing agents, such as chitosan, Teflon or glass microspheres, rutile TiO₂ and ZnO sunblock particles and various other inorganic compounds and crystallites cannot easily be applied this way, or require additional emulsifiers and surfactants for aqueous-based processing. These surfactants and emulsifiers, as well as the chemicals used for pH control, then become part of the finished treatment process and impact the quality of the substrate treatment.

To avoid loss of quality control during finishing operations, fresh chemicals must constantly be added to the finishing bath, so that the concentration of the various components does not change with time or use. However, the bath still must be periodically flushed to avoid interaction between the components and time-dependent degradation of the chemical mixture. The discharge of these finishing chemicals is a waste of chemicals, a cost of operation, and adds to water pollution or requires special, chemical waste handling, at even greater additional cost.

Most textile treatments also require a high degree of laundry durability to avoid loss of the finishing attribute. Producing a laundry-durable treatment requires a means to chemically bond or physically attach the desired chemical agents that provide the targeted fabric-finishing attribute. The aggressive nature of laundry involves both surface agitation and exposure to strong detergents intended to remove stains and soil. Overcoming this cleaning action requires either a chemical bond to the yarn that comprises the fabric, or a polymer coating that resists removal by tightly enveloping the yarn, or both. As an example, for a laundry-durable antimicrobial treatment, chemical methods have been developed that bond the antimicrobial agent to a single fabric, such as cotton. However, such an approach is highly fabric specific and must be developed for each and every fabric. It is desirable to have a fabric finishing treatment that is not fabric-specific, but yet is laundry-durable.

Almost all textile finishing has been developed using water-based, chemical processes. Such water-based processes include the use of aqueous-based solutions, foams, sprays and gels. U.S. Pat. Nos. 7,056,845 and 4,868,262 are examples of aqueous-based finishing processes used for finishing of roll-to-roll textiles or textile fibers. All of the examples in these patents describe a predominance of water in the finishing solution, foam or gel, and the use of various emulsifiers, dispersing agents and copolymers. Heat treatment is used to dry and “cure” the treated fabric and is used to evaporate water from the wet fabric. US Patent Application Publication US2009/0137171 extends this treatment method by the use of a colloidal suspension of silica nanocrystals with an aqueous-based padding process used for improved hydrophobicity treatment.

U.S. Pat. No. 4,193,762 describes the use of an aqueous foam that is applied to a textile surface and which uses pressure rollers to break the foam and impregnate the finishing agent into the textile as a step prior to heat-based drying and curing. This treatment process may be done on one or both sides of the textile.

U.S. Pat. Nos. 7,955,518 and 7,790,238 describe the use of an aqueous-based finishing solution having organic or inorganic solid(s) mixed into the solution at a concentration of at least 5.5 g/1 and which is applied using a padding method, followed by heat curing. Some of the solids added to the finishing liquor in U.S. Pat. No. 7,955,518 are various copolymers and modified silica, which provide added surface roughness to enhance the hydrophobic finishing result. The use of nanoparticles added to a finishing solution can provide a “self-cleaning”, super-hydrophobic property, which is characterized by a contact angle for a drop of water on the treated fabric which is greater than 130 degrees, is also described in US Patent Publication 2008/0090004. In this invention, the treatment is applied by dipping the fabric into the coating composition, padding or by spraying the coating composition, which generally consists of a non-aqueous, organic, liquid solvent. After application of this liquid solvent to the fabric, heat-curing is used to finish the treatment and to evaporate the liquid, organic solvent.

US Patent Publication 2011/0201728 discloses a method for free radical polymerization of various monomers and co-polymers that are dispersed in water. The invention mentions textile finishing, but does not provide any such examples.

US Patent Publications 2009/0028916, 2010/0255210 and 2009/0318044 describe various, loaded microspheres or coated micro-particles as part of the finishing chemistry that is applied with aqueous solution to fabric and other substrates for the purpose of providing cosmetic, pharmaceutical or antimicrobial properties to fabric. The use of coated microspheres is intended to delay the release of chemicals from the substrate and to extend the duration of the treatment. The micro-particles or microspheres are not embedded in a surface polymeric film.

US Patent Publication 2008/0107822 describes a method of coating a textile or nonwoven with a nano-scale thickness of vapor-condensed monomers plus additional chemicals, followed by a plasma-based curing method to polymerize the coated monomer. This approach provides good laundry durability and does not affect the “hand” of the treated fabric. This approach is unsuitable for heat treatment, as the thin coating of condensed, low molecular weight monomer will evaporate in an oven before it will polymerize.

U.S. Pat. No. 4,559,150 issued describes the use of liquid organic solvents that enable the dissolution of a whitening agent for finishing various textile applications, such as curtains or underwear. The examples describe soaking of the textile goods in the organic solution, followed by heat drying.

This invention is in one aspect a method for continuously applying a chemical treatment to a substrate, comprising

a) positioning one or more pieces of a solid chemical mixture having a softening temperature of at least 30° C. proximate to or in physical contact with a surface of the substrate;
b) continuously passing a width of substrate past the positioned piece or pieces of non-particulate chemical mixture and applying the chemical treatment from the non-particulate chemical mixture across at least 80% of the width of at least one surface of the substrate.

The invention is also a method for applying a chemical treatment to a substrate, comprising

a) providing one or more pieces of a solid chemical treatment mixture having a softening temperature of 30° C. to 100° C. and containing at least one monomer that polymerizes through a free radical polymerization process;
b) heat-softening the chemical treatment mixture and supplying the heat-softened chemical treatment mixture to a transfer apparatus without significantly polymerizing the chemical treatment mixture;
c) passing a width of a fibrous substrate into contact with the transfer apparatus and transferring the heat-softened chemical treatment from the transfer apparatus to the fibrous substrate; and then
d) polymerizing the monomer in the solidified chemical treatment on the fibrous substrate through a free-radical polymerization process.

The invention is also method for applying a chemical treatment to a substrate, comprising

a) providing a transfer sheet including a sheet material impregnated or coated with a solid chemical treatment mixture having a softening temperature of 30° C. to 100° C. and containing at least one monomer that polymerizes through a free radical polymerization process;
b) contacting the transfer sheet to a fibrous substrate and heating the transfer sheet in contact with the fibrous substrate to heat-soften the chemical treatment mixture and transfer at least a portion of the heat-softened chemical treatment mixture from the transfer sheet to the substrate without significantly polymerizing the chemical treatment mixture;
c) polymerizing the monomer in the solidified chemical treatment on the fibrous substrate in a free-radical polymerization. As used herein, “without significantly polymerizing” is intended to mean that at the time of the chemical transfer at least 25% of the monomeric composition of the chemical treatment remains in monomeric form, i.e., it is uncured.

The method of the invention provides an economical and efficient way to coat a substrate. No wet chemical bath is necessary, nor is it necessary to apply a foam or gel to the substrate. As a result, the problems associated with such a bath, such as non-uniformity of the composition of the bath over time, the problem of chemical interactions in the bath, the difficulty in applying certain materials such as solid particles and the energy and equipment costs associated with removing the solvent, are eliminated with this invention. This invention minimizes chemical waste and uses minimal water, if any at all. In most cases the chemical treatment mixture contains only low, or negligible levels of volatile organic compounds, and so the issues of worker exposure, release into the environment and vapor capture and recovery associated with the use of those materials is minimized.

Additionally, the problem of finishing solution component exhaustion and the need for constant monitoring of a wet bath composition is avoided, as the solid chemical treatment mixture continuously supplies fresh chemical material of known and constant composition. Additionally, the safety issue created by the shipping, handling, storage and mixing of large amounts of liquid chemicals used for conventional, wet finishing processes is solved by the safe handling and storage of the solid chemical material. Yet another advantage is that shrinkage losses are often significantly reduced because the process does not immerse the substrate in large amounts of solvents or water.

The invention is also an apparatus for applying a solid chemical treatment mixture to a width of substrate, comprising

a) transporting means for holding a substrate and continuously transporting the substrate past and into contact with a chemical transfer apparatus and through a free-radical polymerization zone and;

b) a chemical transfer apparatus for heat-softening a solid chemical treatment mixture and transferring the heat-softened chemical treatment mixture to the substrate and transferring the heat-softened chemical treatment mixture across at least 80% of the width of at least one surface of the substrate as the substrate is transported past and in contact with the chemical transfer apparatus to produce a coated substrate;

c) a free-radical polymerization zone downstream of the chemical transfer apparatus.

The invention is also a solid chemical treatment mixture having a softening temperature of 30° C. to 100° C. comprising at least one monomer that polymerizes by free radical polymerization and a carrier or mixture of carriers in which the monomer(s) are dispersed or dissolved. Often, this carrier is nonpolar to aid in the dissolution of other chemical components in the chemical treatment mixture. This solid chemical treatment mixture may also contain a desired finishing attribute chemical.

FIG. 1 is a schematic drawing of a prior art wet “padding” process used for conventional fabric finishing.

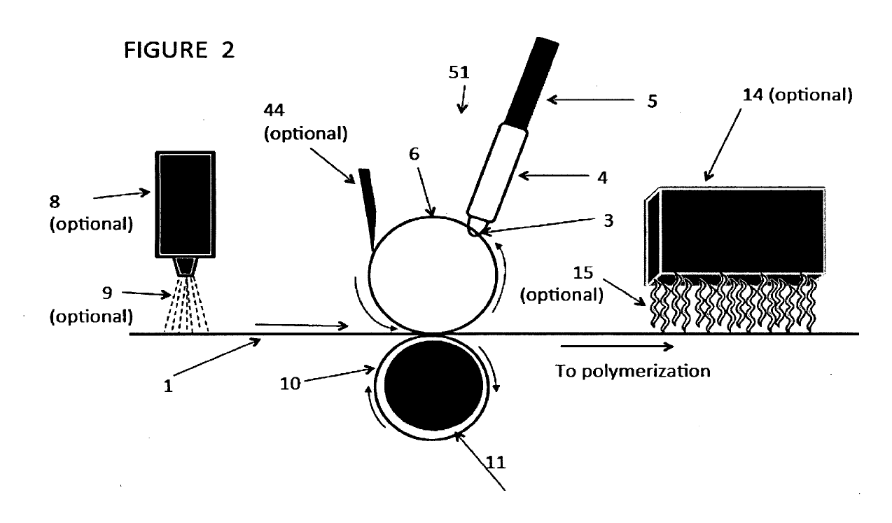

FIG. 2 is a side schematic view of a first embodiment of an apparatus and method of the present invention.

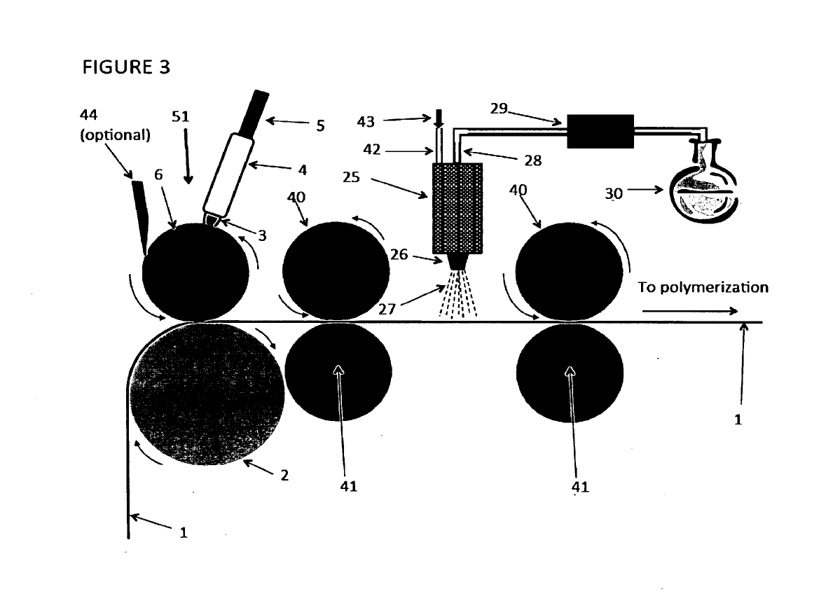

FIG. 3 is a side schematic view of a second embodiment of an apparatus and method of the present invention.

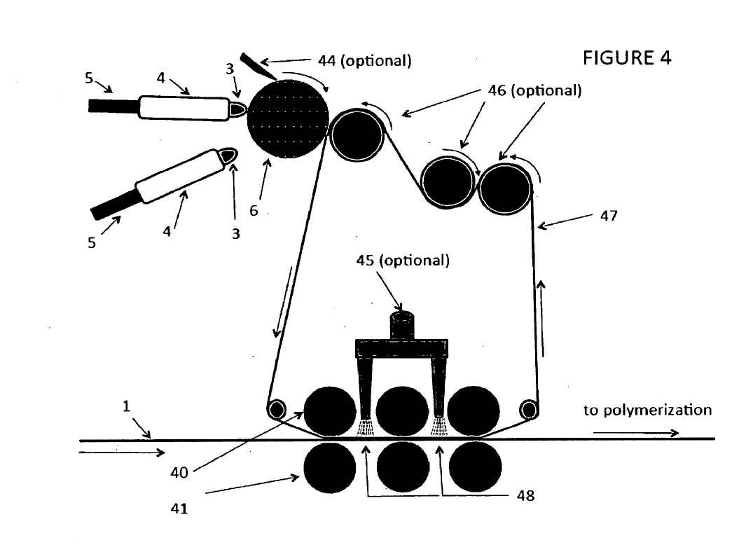

FIG. 4 is a side schematic view of a third embodiment of an apparatus and method of the present invention.

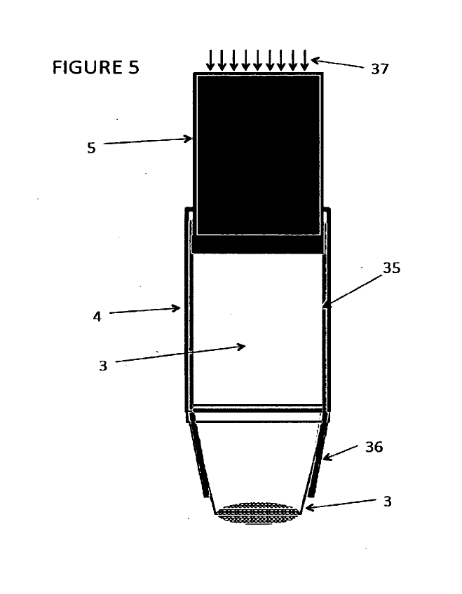

FIG. 5 is a side sectional view of a chemical applicator useful in certain embodiments of the invention.

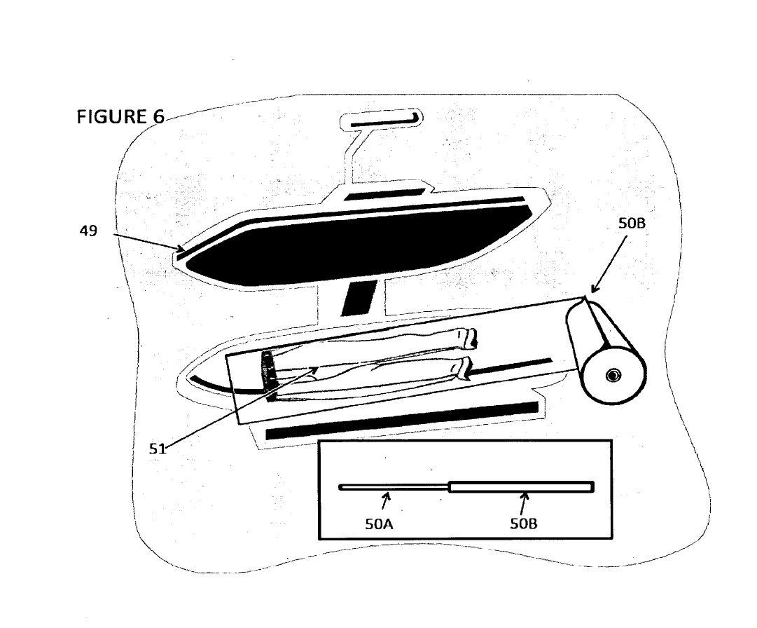

FIG. 6 is a side schematic view of a fourth embodiment of an apparatus and method of the invention.

The apparatus of the present invention includes a chemical transfer apparatus which transfers a normally solid chemical treatment mixture in melted or softened form to a width of a substrate. The solid chemical treatment mixture is supplied into the process in the form of a solid, which may be softened before or during application to the substrate. The apparatus preferably is adapted to apply the chemical treatment mixture to at least 80% of the width of the substrate. The apparatus may comprise a support that holds the substrate against the chemical transfer apparatus.

The transporting means holds the substrate, such as, for example, by supporting it from below or by gripping it in some way, and transports the substrate in contact with a chemical transfer apparatus as described more fully below. The transporting means preferably pulls or holds substrate 1 at its full width as it is transported through the process. The transporter means may be, for example, the drive mechanism in a tenter frame, one or more drive rollers, a winding apparatus which can be located downstream of the chemical applicator means, a moving belt, or similar device. Two or more of such devices can be used in combination to form the transportation means. In embodiments in which additional processing steps are performed, such as, for example, a polymerization or curing step, the transporting means preferably also transports the substrate past the corresponding apparatus. In embodiments in which an impregnated transfer sheet is used, the transporting means may be simply be a means of moving and replacing the spent transfer sheet when the chemical transfer is completed.

The chemical transfer apparatus applies the heat-softened chemical treatment mixture to the substrate as the substrate is transported into contact with the transfer apparatus. An important advantage of the invention is that the chemical treatment mixture can be applied across substantially the entire width of the substrate. Therefore, the chemical applicator means is in some embodiments adapted to apply the chemical treatment mixture across at least 80% of the width of the substrate, and more preferably across the entire width of the substrate. The chemical transfer apparatus can have various designs including those described in the Figures.

A first embodiment of an apparatus of the invention is illustrated in FIG. 2. In this embodiment, substrate 1 is transported past chemical transfer apparatus (indicated generally at 51) where a chemical treatment mixture is transferred across the width of at least one surface of substrate 1. The transporting means in this embodiment includes nip rollers 6 and 11, which are driven and pull substrate 1 through the apparatus. In this and in all other embodiments shown, additional transporting means as described above can be provided to replace and/or supplement rollers 6 and 11.

In the embodiment shown in FIG. 2, chemical transfer apparatus 51 includes mounting 4 and tensioning apparatus 5, which holds solid chemical treatment mixture 3 against transfer roller 6, which in turn is in contact with substrate 1. In this embodiment, solid chemical treatment mixture 3 is transferred to substrate 1 indirectly by first applying it to transfer roller 6, and then contacting transfer roller 6 with substrate 1. Roller 11 (with optional spongy cover 10) supports substrate 1 and holds it against transfer roller 6. Transfer roller 6 may be heated to soften the solid chemical treatment mixture 3.

If transfer roller 6 is not heated, the apparatus includes alternative heating means for heat-softening the chemical treatment mixture 3 before or during application. Such alternative heating means may include, for example, radiant heaters, electrical heaters, hot air heaters, the application of steam, infrared heating, and the like.

The heating means, whether part of the chemical transfer apparatus or a separate apparatus, heats solid chemical treatment mixture 3 to above its melting or softening temperature. Solid chemical treatment mixture 3 preferably is melted or softened within 30 seconds, preferably within 5 seconds prior to applying it to substrate 1, and remains in such a melted or softened state until it is applied to substrate 1.

In the embodiment shown in FIG. 2, roller 6 and/or nip roller 11 may be heated to heat substrate 1 before or as the melted or softened chemical treatment mixture is applied. Alternately, additional apparatus can be provided to heat substrate 1 prior to, or at the time it contacts the transfer apparatus. If heated, substrate 1 may be heated, for example, to a temperature of 30 to 100° C., preferably 30 to 75° C., more preferably to 40 to 65° C., and still more preferably to 45 to 55° C.

In some embodiments, only some of the components of solid chemical treatment mixture 3 are melted or softened in this step. It is generally sufficient to soften only that portion of the chemical treatment mixture which allows the formation of a viscous fluid in which other components are entrained and carried through the process. Thus, in some cases, some components are intended to remain as solid particles, to provide a desired degree of roughness to the surface, or are intended to protrude out of a final, thin polymer film to provide antimicrobial or flame retardant properties, or for other finishing attributes. This is acceptable, as any unmelted or unsoftened components, including any nano- or micro-scale particles, will be carried onto substrate 1 along with the melted or softened portion of the chemical treatment mixture, later to be permanently polymerized in place.

Transfer roller 6 may have a metal, ceramic, polymeric or other surface. It may have a low friction, non-absorbing surface, such as a Teflon or polyimide (Kapton®) surface. It may have a textured, or micro-machined surface to contain a desired quantity of chemical material for the transfer. For some applications, transfer roller 6 may be made of high density foam, similar to a certain paint rollers. Transfer roller 6 and/or roller 11 may be driven, and when driven will constitute all or a part of the transporting means. As before, different and/or additional transport means can be provided. Transfer roller 6 and roller 11 may rotate at the same or different speeds or in different directions. For example, transfer roller 6 may rotate faster than roller 11 and faster than would be required to maintain the linear speed of substrate 1. This helps smooth out the coating and helps to uniformly distribute the chemical treatment mixture onto substrate 1. Transfer roller 6 and/or roller 11 may have ridges, or other surface topographic features. These features can give rise to corresponding features in the applied coating, which is especially desirable when the chemical treatment mixture includes a colorant. In this way, aesthetic features can be incorporated onto the substrate with the application of the chemical treatment mixture.

As shown in FIG. 2, optional doctor blade or wiper blade 44 or similar apparatus may be provided to uniformly spread chemical treatment mixture 3 across transfer roller 6 and/or help control the thickness of the film of chemical treatment mixture across transfer roller 6.

FIG. 5 illustrates an embodiment of an apparatus for holding solid chemical treatment mixture 3 and supplying the solid chemical treatment mixture 3 to a chemical transfer apparatus 51, such as shown in FIGS. 2 and 3. In FIG. 5, solid chemical treatment mixture 3 is mounted within the mounting 4, which as shown is lined with optional low-friction, low chemical absorption coating 35. Coating 35 may be, for example, a Teflon sleeve or cover or other polymeric material. As shown in FIG. 5, tensioning apparatus 5 is a simple plunger which, when pressure 37 is applied, presses down upon solid chemical treatment mixture 3 and pushes solid chemical treatment mixture 3 through nozzle applicator 36 and out of mounting 4. In this way, chemical treatment mixture is made available for heat-softening and supplied to chemical treatment apparatus 51. Tensioning apparatus 5 may have many other alternative designs, such as a spring mechanism, a screw mechanism, a hydraulic mechanism or other similar mechanism by which pressure is applied to chemical treatment mixture 3. Nozzle applicator 36 may be heated to, for example, a temperature of 25 to 50° C. to slightly soften solid chemical treatment mixture 3 as it is extruded out of mounting 4. Nozzle applicator 36 may define the size and shape of that portion of solid chemical treatment mixture 3 that is pushed out of mounting 4.

In the embodiment shown in FIG. 2, heat is optionally applied to the treated substrate after application of the chemical treatment mixture. Heating means 14 for heating and softening solid chemical treatment mixture on the treated substrate applies heat energy (generally designated by reference numeral 15) to treated substrate 1. This heat energy helps to spread the applied chemical treatment mixture evenly across substrate 1 and helps to smooth its surface. Heating means 14 may also be used to help polymerize, or cure the applied chemical treatment, as all or part of the curing operation. Heating means 14 may be, for example, a hot air blower, a microwave radiation source or similar device that delivers heat to the coated substrate. Another advantage of this embodiment is that the heat supplied by heating means 14 may generate free radicals in the transferred chemical treatment that induce the polymerization of the monomer(s) contained in the chemical treatment, although the heat conditions supplied by heating means 14 alternatively can be selected so that little or no polymerization occurs at this stage.

Another optional feature is present in the embodiment shown in FIG. 2. Sprayer 8 applies spray or aerosol 9 of a solvent, plasticizer, fabric softener or some component thereof onto the substrate in advance of the transfer apparatus 51. A coating of the chemical treatment mixture 3 is then applied to the resulting solvent-moistened substrate 1 in the same general manner as just described. The liquid applied to substrate 1 via spray 9 may help to dissolve one or more components of chemical treatment mixture 3, when chemical treatment mixture 3 is brought into physical contact with substrate 1, or may provide some other property, such as softening or fire retardant properties of the final polymer treatment.

In the embodiment shown in FIG. 2, a single chemical transfer apparatus is used to coat the entire width of substrate 1. Thus, a single piece of solid chemical treatment mixture 3, a single mounting 4 and a single transfer roller 6 extends the full width of substrate 1, thereby coating the entire width of the substrate. Alternately, in this and the other embodiments described herein, multiple narrower chemical transfer apparatuses may be mounted side by side, in a staggered formation or otherwise to collectively coat at least 80% of the width of substrate 1. In the latter case, each of these apparatuses may slightly overlap the adjoining apparatus to ensure coating across the entire width of the substrate.

Pressure provided by transfer roller 6 and nip roller 11 can be used to at least partially control the depth of penetration of the chemical treatment 3 into substrate 1. For a surface coating only, such as for a single-sided treatment of the substrate, or for use with plasma polymerization, it is sometimes preferred to apply only a minimum of force, such as a force in the range of 500-30,000 dynes, and preferably in the range of 700-2000 dynes. This is sufficient to spread the softened chemical coating without pushing the chemicals into the interior of the substrate, which may be undesirable in some cases, such as when the substrate is to be cured using a plasma or plasma-generated free radicals in a subsequent curing step. Greater forces, such as 65,000-250,000 dynes, may be applied by rollers 6 and 11 if greater penetration of the chemicals into substrate is desired. Dyeing, for example, is one of several such finishing treatments in which greater depth penetration into the substrate may be desired.

Conditions during the step of applying the chemical treatment mixture to the substrate are selected such that no significant curing of the monomer(s) occurs during that step. Significant curing results in the formation of a polymeric material that has a melting temperature above 100° C., and/or results in the polymerization of at least 75% of the weight of the monomer(s). Preferably, less than 50%, more preferably less than 25% of the monomer(s) by weight is polymerized during the step of applying the chemical treatment mixture to the substrate. As used herein, “curing” and “polymerization” are used interchangeably.

Generally, at least one condition needed for polymerization is lacking during the application step. Such a needed condition is typically a lack of a source of free radicals. If the chemical treatment mixture contains a free radical initiator, temperature conditions during the chemical application step are generally maintained below the decomposition temperature of the free radical initiator. In addition, it is preferred that no other source of free radical (such as those described below) is present during the chemical application step.

It is possible to modify any of the embodiments shown in FIGS. 2-3 to provide successive multiple chemical transfer apparatus, each of which, in turn, applies the chemical treatment mixture (or portion thereof) to the substrate. The chemical treatment mixture applied at each transfer apparatus may all be the same, in which case the purpose of using multiple transfer apparatuses is to provide a heavier dosage than can be provided conveniently using only a single transfer apparatus. Alternatively, it is also possible to provide two applications of two different chemical treatment mixtures in this manner.

A preferred coating weight applied to the substrate by each chemical transfer apparatus is 1 to 70 g/m³, especially 2 to 50 g/m³ or 3 to 25 g/m³. Heavier coating weights can be applied using two or more chemical transfer apparatuses in series, or by passing the substrate through a chemical transfer apparatus multiple times.

Similarly, multiples sets of chemical transfer apparatuses may be used for the purpose of providing different penetration depths for the chemicals provided by the first chemical transfer apparatus and the chemicals provided by a subsequent chemical transfer apparatus. An example might be the use of an inexpensive monomer that is part of the chemical treatment mixture applied by the first chemical applicator, such as stearyl acrylate, used to provide a “base” treatment that penetrates deeply into the substrate and helps keep an expensive chemical, such as 2-(perfluorohexyl) ethyl acrylate, at or near the surface of the substrate, for improved water and oil repellency. In another example, a first chemical treatment mixture might contain a dye which desirably penetrates through the full thickness of the substrate, whereas a subsequently applied chemical treatment mixture might apply a surface-based, water repellent or wicking finish to the surface of the dye-impregnated substrate.

Another embodiment of the invention is shown in FIG. 3. In this embodiment, a coating of chemical treatment mixture 3 is applied and spread in the same manner as described in FIG. 2, followed by application of a liquid or vapor treatment spray. In FIG. 3, reference numerals 51, 1, 3, 4, 5, 6, 11 and 44 designate the same components, which perform the same function as the corresponding numerals in FIG. 2. Sprayer 25 is equipped with nozzle 26, and applies a fine aerosol mist, vapor or liquid spray 27 to substrate 1 after chemical treatment mixture 3 is applied to substrate 1. Feed lines 28 and pump 29 transfer a liquid from reservoir 30 to sprayer 25 and nozzle 26. Mist, vapor or spray 27 contacts substrate 1 with the applied chemical coating mixture. As shown, substrate 1 is then optionally passed through nip rollers 40 and 41, which provide pressure and optionally heat to substrate 1.

The composition of mist, vapor or spray 27 can vary. Mist, vapor or spray 27 may be or include a solvent for a carrier or mixture of carriers contained in chemical treatment mixture 3, and may help soften or dissolve the chemical treatment mixture and/or assist in spreading the chemical treatment mixture 3 across substrate 1 and/or to assist in carrying chemical treatment mixture 3 into substrate 1. The material(s) in mist, vapor or spray may be, for example, liquids that cannot easily be converted into solid form and/or which do not form a stable, solid mixture when combined with the other ingredients of chemical treatment mixture 3. For example, the component(s) of mist, vapor or spray 27 might in some cases cause the premature polymerization of chemical treatment mixture 3 if directly mixed into the solid chemical treatment mixture 3. Hydrogen peroxide, which is a useful free radical polymerization initiator, is an example of such a component. Hydrogen peroxide cannot be stably mixed with certain monomers that polymerize in a free radical polymerization and so must be sprayed or otherwise transferred onto the treated substrate downstream of the chemical transfer apparatus 51.

Sprayer 25 of FIG. 3 is also well adapted to provide very light dosages of a material, such as, for example, a dosage of less than 1 mL/yd². Sprayer 25 may be adapted to include an evaporator and nozzle 26, such as that described in US Patent Application 20080107822. In such an embodiment, a fluid is heated within sprayer 25 to a temperature at or near its boiling point and becomes converted to a vapor. By adding a carrier gas 43 into sprayer 25 via gas feed line 42, it is possible to apply very light dosages of the condensed vapor onto substrate 1. In such an embodiment, substrate 1 may be chilled to promote condensation of the sprayed material. For examples, roller 31 may be chilled, set, for example, to a temperature of 0-20° C., preferably 10-15° C., to chill substrate 1 and thereby aid in the condensation of the vapor 27 onto the substrate 1. After condensation or precipitation onto the substrate, condensed vapor, spray or mist 27, may in some cases react with the surface coating on substrate 1 that is produced by transfer of solid chemical treatment mixture 3 to the substrate 1.

A free radical polymerization step is performed after the chemical treatment mixture is applied to the substrate. In general, the polymerization step is performed by subjecting to the treated substrate to a source of free radicals. The apparatus of the invention further includes a polymerization zone for polymerizing the free-radical polymerizable monomer(s) contained in the applied chemical treatment mixture. The polymerization zone contains apparatus that exposes the treated substrate to a source of free radicals or exposes the treated substrate to conditions that promote the generation of free radicals. This is preferably performed by transporting the treated substrate past or through a polymerization zone using a transporting means previously described. It is preferred that the transport means be adapted to move the substrate continuously past the source of free radicals (or the condition within the polymerization zone that promotes the formation of free radicals), thereby continuously performing the curing reaction.

Free radicals can be provided in several ways. If the chemical treatment mixture contains a heat-activated free-radical initiator, free radicals can be provided by heating the treated substrate to a temperature at which the free radical initiator generates free radicals. Alternatively, the treated substrate may be contacted with a source of free radicals, such as a plasma. The treated substrate may be exposed to ultraviolet radiation, e-beam radiation or other ionizing radiation source to produce free radicals. The treated substrate can be contacted with an additional component, not present in the chemical treatment mixture 3, such as a spray of hydrogen peroxide, to generate free radicals for the curing reaction. Preferably, the polymerization process on the treated substrate, which requires free radicals, occurs treated substrate downstream from the chemical transfer apparatus. (i.e., in the direction of the movement of the substrate through the polymerization zone). This helps avoid polymer buildup on the chemical transfer apparatus.

Heat can be applied to the treated substrate in any convenient way, including by a heater and blower apparatus which blows a hot gas onto the coated substrate, by passing the treated substrate through an oven or tenter frame, by pulling the treated substrate over a series of heated rolls, by providing a microwave generator and exposing the treated substrate to the generated microwaves, and the like.

Suitable plasma-generating apparatus for generating free radicals include apparatus for generating microwave-based plasmas, corona discharge plasmas, atmospheric-pressure plasmas including dielectric-barrier discharges and helium-based plasmas such as those described in U.S. Pat. Nos. 6,262,523, 8,016,894, 7,329,608 7,025,856, US Patent Publications 2009/0200948 and 2005/0093458, U.S. patent application Ser. No. 13/830,800 (filed 14 Mar. 2013), and vacuum-based plasmas. The treated substrate may be immersed in a plasma or otherwise exposed to active chemical agents, such as free radicals produced by the plasma. Such active chemical agents may be, for example, blown out of the plasma-generating apparatus and caused to impinge upon the coated substrate. Thus, in some embodiments, the apparatus of the invention includes a plasma generator, and means for exposing the treated substrate to the generated plasma and/or free radicals or other active chemical species formed in, or by, the plasma.

In other embodiments of the invention, the chemical treatment mixture is applied to the substrate using a transfer sheet that has been impregnated or coated with the chemical treatment mixture 3. The transfer sheet typically is removed from the substrate after the chemical treatment mixture is transferred. In the embodiment illustrated in FIG. 4, the transfer sheet 47 is continuously impregnated or coated with the chemical treatment mixture 3 and, the chemical treatment mixture is continuously applied from the transfer sheet to the substrate.

Thus, in FIG. 4, solid chemical treatment mixture 3 is supplied through mounting 4 and tensioning apparatus 5, as described with respect to FIG. 2. A film of the melted or softened chemical treatment mixture 3 is formed onto transfer roller 6, and may be spread using optional doctor blade 44 or similar apparatus, and from there transferred onto transfer sheet 47. As shown, transfer sheet 47 is provided in the form of a continuous belt which moves along rollers 40 and 46. Upon contacting transfer roller 6, transfer sheet 47 becomes impregnated or coated with chemical treatment mixture 3. Chemical treatment mixture 3 may re-solidify on transfer sheet 47 before being transferred to substrate 3. Transfer sheet 47 carries chemical treatment mixture 3 to substrate 1, to which it is contacted by, for example, passing transfer sheet 47 and substrate 1 between nip roller pair 40 and 41. One or both of nip rollers 40 and 41 (or any of rollers 46) may be driven, and if so can form part or all of a transport means for moving substrate 1 past and into contact with transfer sheet 47. Rollers 40 and 41 preferably are heated to soften chemical treatment mixture 3 upon transferring it to substrate 1. Alternatively, additional or different heating means (radiant heaters, steam heaters, electrical heaters, microwave heaters, and the like) can be provided to soften chemical treatment mixture 3 before, during or after transferring it from transfer sheet 47 to substrate 1. Optional sprayer 45 can provide a mist, vapor or spray 48 onto substrate 1, similar to sprayer 25 in FIG. 2. As shown, sprayer 45 can apply the mist, vapor or spray after transfer sheet contacts substrate 1, to help wash chemical treatment mixture 3 from transfer sheet 47 to substrate, or to apply another chemical thereto. Sprayer 45 also can provide steam to heat the substrate and/or the applied chemical treatment mixture. Alternatively or in addition, sprayer 45 can be positioned upstream of rollers 40 and 41, or further downstream (i.e., in the direction indicated by the arrows in FIG. 4).

FIG. 4 also shows a second, solid chemical treatment mixture 3 with mounting 4 and tensioning apparatus 5 that is not in direct contact with transfer roller 6. When the first chemical treatment mixture is exhausted, this second unit could be moved in place to contact transfer roller 6, while the first chemical treatment mixture is replaced. This provides a means for continuous processing and product treatment.

In the embodiment shown in FIG. 4, free radical polymerization occurs after transfer sheet 47 contacts and transfers chemical treatment mixture 3 onto substrate 1. Means for providing free radicals (not shown in FIG. 4) are suitably as described with respect to FIG. 2. Alternatively, in this embodiment, free radicals can be provided at the same time as transfer sheet 47 transfers chemical treatment mixture 3 onto substrate 1, again using methods as described before. For example, if chemical treatment 3 contains a heat-activated free radical initiator, heat provided by rollers 40 and 41 (or through other means) can trigger the free radical initiator to generate free radicals at that point. This will initiate a gradual polymerization process (taking up to several hours for completion) that can avoid the need for an additional downstream heat source, such as a tenter frame. This embodiment may be used, for example, for treatment of temperature-sensitive fabric or nonwovens, such as polypropylene, rayon, silk, leather and certain aramids.

The embodiment shown in FIG. 4 is adapted for continuous application of a chemical treatment mixture to a substrate, which may be provided to the process in the form of roll goods. FIG. 6 illustrates an embodiment of the process better adapted for discontinuous operation, and better adapted for applying a chemical treatment to a garment or other fabric that is not in the form of roll goods. The method illustrated in FIG. 6 may be used, for example, to treat a piece of apparel, or hospitality fabrics, such as linens, table cloths and napkins, home furnishing items, such as curtains, blankets, bedspreads, area rugs and wall hangings and the like, and individual technical textiles, such as liners for automotive or recreational vehicles. In FIG. 6, transfer sheet 50B is coated or impregnated with the chemical treatment mixture of the present invention. Transfer sheet 50B is placed over (or under) garment 51. Heat and pressure are applied to transfer sheet 50B and garment 51 using iron or steam press 49. The heat and pressure applied via iron 49 transfer some or all of the chemical treatment mixture onto garment 51. After transfer of the chemical treatment mixture, spent transfer sheet 50A contains a reduced amount, if any, of the chemical treatment mixture. In cases in which the chemical treatment mixture contains a heat-activated free-radical initiator, the heat supplied by iron 49 can trigger and activate the initiator, thereby generating free radicals and initiating polymerization. For faster polymerization, the finished garment may simply be heat-treated, for example, by heating to a temperature of 60 to 110° C. Heating can be also performed, for example, using a standard or commercial laundry dryer. Generally, 10 to 50 minutes in a laundry dryer at medium to high heat setting is sufficient. Alternatively, any of the other methods described above for contacting the treated substrate with free radicals can be performed.

Transfer sheet 47 may be, for example, paper, a woven, knitted, entangled or non-woven fabric, cardboard; a polymer film, a metal foil, or other material onto which the chemical treatment mixture can be coated or into which the chemical treatment mixture can be reversibly impregnated. Transfer sheet 47 preferably is flexible, and is preferably dimensionally and thermally stable under the conditions of the step of transferring the chemical treatment mixture to the fibrous substrate.

If desired, any of the coating methods described in FIGS. 2, 3, 4 and 6 can be performed on one or both sides of the substrate.

The substrate can be any fibrous material that is capable of being carried through the coating process and the polymerization process. By “fibrous”, it is meant that a surface of the substrate to which the chemical treatment mixture is applied is made up of or includes fibers of at least one type, and that the substrate includes spaces between the fibers into which the applied chemical treatment mixture can penetrate. The fibers may be, for example, woven, knitted, entangled, knotted, felted, glued or otherwise formed into a fabric, non-woven or textile having sufficient mechanical integrity to be carried through the process of the invention.

Flexible materials are preferred substrates. The substrate is in the form of a sheet having a thickness of no greater than about 12 mm and a width of at least 100 mm, and preferably has a thickness of no greater than 8 mm and a width of at least 300 mm. The substrate can have any smaller thickness provided it has enough mechanical integrity to be conducted through the process. The width of the substrate may be as much as 7 meters or more.

The substrate is in some embodiments a woven, knitted or non-woven fabric. Such a fabric includes fibers that may be, for example, a natural fiber such as cotton, hemp, wool, linen, silk, tencel, rayon, bamboo, cellulose and the like, or a synthetic fiber such as nylon, aramid, polypropylene, polyester, polyacetate, polylactic acid, cellulose ester or other fiber and blends of any two or more of the above. It may a smooth or fleeced fabric and it may contain a stretchable fiber, such as Elastane, Lycra, or Spandex.

In other embodiments, the substrate may be coated on one side as is the case, for example, with leather, or synthetic leather products, such as vinyl, which have an exposed fibrous surface on the side that is coated. The substrate may be a cellulosic material such as paper or cardboard and the like.

The chemical treatment mixture contains at least one monomer that can be polymerized in a free radical polymerization. Typically, the chemical treatment mixture will in addition include at least one carrier or a mixture of carriers. The carrier or mixture of carriers preferably includes one or more non-functional materials which form a continuous phase in which the monomer(s) and finishing attribute chemicals and other functional ingredients as described below (if any) are dissolved and/or suspended. The carrier or mixture of carriers is selected so the solid chemical treatment mixture is solid at 20° C. and has a softening or melting temperature from 30 to 100° C.

The chemical treatment mixture may also contain one or more finishing attribute chemicals as described below, and may further contain other functional ingredients as described below.

The monomer(s) may constitute, for example, 2 to 75%, preferably 5 to 60% and more preferably 20 to 60% of the weight of the chemical treatment mixture.

The carrier or mixture of carriers may constitute, for example, 5 to 90%, preferably 10 to 75% by weight of the chemical treatment mixture.

Finishing attribute chemicals, when present, may constitute from 0.01 to 70%, preferably 0.01 to 10% of the weight of the chemical treatment mixture.

Other functional materials may in the aggregate constitute 0.01 to 70%, preferably 0.01 to 50%, more preferably 0.01 to 25%, and still more preferably 0.01 to 10%, of the weight of the chemical treatment mixture.

The monomer(s) are polymerizable by free radical polymerization. The monomer(s) therefore contain one or more groups that polymerize in the presence of free radicals. The polymerizable groups may be, for example, vinyl, aryl aromatic, acrylate, methacrylate and the like. The monomers preferably are liquids or solids at room temperature, have boiling points at least 50° C., and preferably higher, than the melting or softening temperature of the chemical treatment mixture.

The monomer(s) may be classified by whether they form either hydrophilic or hydrophobic polymers. When moisture absorption is desired (such as the skin-side of a fabric), mattress sheets, outdoor performance and sports apparel, socks and shoe linings, bath towels, underwear, diapers, table linens and napkins or for various technical textile applications, such as bandages, filtration, membranes, biocompatible materials and disposable wipes), hydrophilic monomers may be used. Examples of hydrophilic monomers include one or more of the following, but not limited to: acrylic acid, acrylamide, poly ethoxy (10) ethyl methacrylate, hydroxypolyethoxy (10) allyl ether, n,n-dimethylacrylamide, methacrylic acid, beta-carboxyethyl acrylate, sodium 1-allyloxy-2 hydroxypropyl sulfonate, diallyl maleate, 2-cyanoethyl acrylate, acrylonitrile, methylmethacrylate and allyl phenyl ether.

Hydrophobic monomers are useful for water or oil repellency applications, such as water or stain-repellent treatments, moisture barriers, battery and fuel cell separators, bandages, antimicrobial fabrics, carpet stain and fade protection, wall and window furnishings, body armor and other para-aramids for ballistic protection, rain gear and outdoor furniture coverings and upholstery, leather or canvas shoe and boot treatments, uniforms and other apparel, leather upholstery and apparel and other automotive and furniture upholstery, tents, awnings and tarpaulins, umbrellas, hospital scrubs and gowns, medical covers, blankets and bedding, mattress ticking, automotive nonwovens, outdoor performance and sports apparel. Examples of hydrophobic monomers include, but are not limited to, one or more of the following: hexyl acrylate, octyl acrylate, octadecyl acrylate, lauryl acrylate, 2-(perfluorobutyl)ethyl acrylate, 2-(perfluorohexyl)ethyl acrylate, 2-(perfluorooctyl)ethyl acrylate, 2-(perfluorodecyl)ethyl acrylate, 2-(perfluorobutyl)ethyl methacrylate, 2-(perfluorohexyl)ethyl methacrylate, 2-(perfluorooctyl)ethyl methacrylate, lauryl methacrylate, stearyl methacrylate, 2-(perfluorodecyl)ethyl methacrylate, and 2-(perfluorooctyl)ethyl trichlorosilane. Hydrophobic or oleophobic oligomers and polymers may be added to the monomers to help accelerate processing. These macromolecules will graft-polymerize with the monomeric content of the chemical treatment mixture during monomer polymerization.

The polymer formed by polymerizing the monomer(s) may fully or partially encapsulate the yarn or fibers that make up the substrate. The polymer may penetrate the yarn and form a chemical bond to the yarn or fibers in some embodiments. In embodiments in which the chemical treatment mixture contains a finishing attribute chemical, this polymer often serves as a binder which affixes the finishing attribute chemical to the substrate. Thus, the finishing attribute chemical in some embodiments becomes dissolved or anchored using the polymer formed by curing the monomer(s).

The carrier or mixture of carriers preferably is a malleable material that, at 20° C., can be deformed under light pressure, such as thumb pressure. The carrier material(s) preferably are not curable under the conditions of the inventive process, and more preferably do not provide by themselves finishing attributes as described below.

When a mixture of carriers is used, the components of the mixture may be soluble or miscible in each other to form a single-phase carrier.

The carrier or mixture of carriers preferably includes at least one solid, low melting compound selected from (i) a solid (at 20° C.) aliphatic monoalcohol or aliphatic monocarboxylic acid having 14 to 30 carbon atoms; (ii) an ester of a fatty acid and a fatty alcohol, the ester having 18 to 48 carbon atoms, preferably 20 to 36 carbon atoms; (iii) a polyether having one or more hydroxyl groups and a pure phase melting or softening temperature from 30 to 100° C.; (iv) a polysiloxane, which can be linear, branched or cyclic; (v) a polysilane-poly(alkylene glycol) copolymer; (vi) a wax, such as a polyethylene wax, bees wax, lanolin, carnauba wax, candelilla wax, ouricury wax, sugarcane wax, jojoba wax, epicuticular wax, coconut wax, petroleum wax, paraffin wax and the like; (vii) a fluoropolymer, (viii) solid vegetable and/or animal oils or fats; or (viii) another organic oligomer or polymer having a pure phase melting or softening temperature between 30 and 100° C.

Among the aliphatic monoalcohols are fatty alcohols, including saturated fatty alcohols such as 1-dodecanol, 1-tetradecanol, 1-hexadecanol, 1-octadecanol, and the like, as well as fatty alcohols have one or more sites of carbon-carbon unsaturation in the fatty alcohol chain.

Among the useful esters of a fatty acid and a fatty alcohol are, for example, hexyl octadecanoate, octyl octadecanoate, dodecyl octadecanoate, hexadodecyl octadecanoate, and the like. The fatty acid and/or fatty alcohol portions of the ester may contain one or more sites of carbon-carbon unsaturation.

Suitable polyethers are polymers of one or more cyclic ethers such as ethylene oxide, propylene oxide, tetramethylene glycol and the like. The molecular weight is high enough to produce a polymer having a melting temperature between 30 and 100° C. The polyether may contain one or more hydroxyl groups. It may be linear or branched. The polyether may contain terminal alkyl ester groups. Specific examples of suitable polyethers include poly(ethylene oxide), monoalkyl esters of a poly(ethylene oxide), poly(propylene oxide), monoalkyl esters of a poly(propylene oxide), ethylene oxide-propylene oxide copolymers and monoalkyl esters thereof, poly(tetramethylene oxide) and the like.

Useful polysiloxanes include, for example, solid (at 25° C.) poly(dimethyl siloxane) and copolymers thereof. The polysiloxane may be linear, branched or cyclic. Useful siloxane-poly(alkylene glycol) copolymers include, for example, poly(dimethyl siloxane-poly(ethylene glycol) copolymers which can have a block or graft structure. The polymer chain length may be selected to adjust the viscosity of the mixture when the chemical treatment mixture is heat softened.

Useful fluorine-containing polymers include polymers of a fluorinated, ethylenically unsaturated monomer such as polytetrafluoroethylene, poly(vinyl fluoride), poly(vinylidene fluoride, poly(hexafluoropropylene, poly(perfluoropropylvinylether), poly-(perfluoromethylvinylether), poly(chlorotrifluoroethylene) and the like.

Other organic polymers that are useful as a component of the carrier or mixture of carriers includes low molecular weight polyamides, low molecular weight polyethers, low molecular weight polystyrene, low molecular weight acrylate polymers and copolymers such as poly (ethylene glycol) methyl ether methacrylate (PEGMEA), polyacrylamide, poly(N-isopropylacrylamide), poly(acrylic acid), low molecular weight thermoplastic cellulose ethers and esters, poly(2-ethylacrylic acid), poly(vinylphosphonic acid), poly(sodium 4-styrenesulfonate), and poly(2-ethyl-2-oxazoline), and the like.

In addition, a mixture of carriers may include one or more chemicals that are liquid at 20° C., provided that such a mixture of carriers is a solid having a melting temperature as described before. The liquid chemicals may function, for example, to adjust the melting temperature of the carrier mixture to within the aforementioned ranges, to plasticize and/or soften the carrier mixture, to help dissolve or suspend the monomer(s), polymerization initiator chemical(s), colorant(s), and/or finishing attribute chemical(s), or to help spread the chemical treatment mixture across the substrate and/or to reduce the surface tension of the chemical treatment mixture on the substrate. Among such liquid chemical components include, for example, water; silicone oils such as cyclopentasiloxane, polydimethylsiloxane (PDMS) oil, octamethylcyclotetrasiloxane, polymethylhydrosiloxane (PMHS) oil, and liquid cyclomethicones; liquid polyethers and polyether mono alkyl esters such as PPG-14 monobutyl ester; liquid alkanes such as n-hexane, n-pentane, n-heptane, henicosane, docosane, tricosane, tetracosane, pentacosane, hexacosane, heptacosane, octacosane, nonacosane, triacontane and the like; liquid alcohols such as n-propanol, isopropanol, n-butanol, t-butanol, methanol and ethanol; fluorinated alkanes such as perfluorohexane, perfluoroheptane, perflurodecane-pinane, perfluorodecane-octane, perfluorododecane and the like; chlorinated alkanes and chlorinated aromatic compounds such as isoamyl chloride, isobutyl chloride and benzyl chloride; alkane diols and polyalkylene glycols such as ethylene glycol, propylene glycol, diethylene glycol, triethylene glycol, dipropylene glycol, tripropylene glycol and 1,4-butane diol; liquid esters such as diisopropyl sebacate and glycerol tripalmitate; ketones such as acetone and methyl ethyl ketone; liquid fatty acids such as stearic acid, oleic acid, palmitic acid, lauric acid and the like; 1-naphthalamine; biphenyl; benzophenone; diphenyl amine; 1,2-diphenylethane; maleic anhydride; pyrazine; thymol; glycerin; sorbitol or other sugars; and dibenzylidene sorbitol. Viscosity modifiers and/or thixotropic agents such as fumed silica, silica gel or silica microcrystals also may be present as part of the carrier material.

A “finishing attribute chemical” is a compound, other than the carrier and monomer(s), which remains with the substrate after the treatment process of the invention and imparts some desirable characteristic to the substrate. It is noted that some monomers, when polymerized, may also provide certain attributes, such as hydrophobicity or hydrophilicity, to the substrate. Examples of finishing attribute chemicals include, for example:

a) hydrophilic treatments, i.e. substances that promote wicking of water or help the treated substrate to absorb water;

b) hydrophobic treatments, i.e., chemicals that impart water-repellency and/or hydrophobic characteristics to the treated substrate;

c) oleophobic treatments, i.e., substances that render the treated substrate not readily absorbent to fats and oils, or repellent to fats and oils;

d) super-hydrophobicity agents; i.e., substances that impart very high)(>130° contact angles of a water droplet with a surface of the treated substrate. This can impart self-cleaning or high-performance, water-repellent properties to the coated substrate. The super-hydrophobicity agent may include solid particles sized from 50 nm to 100 microns, and which remain unaffected by the treatment process, other than being anchored by the polymer. Examples of such solid particles are powdered Teflon and other PTFE powders, silica gel particles, fumed silica, glass or other ceramic particles, polystyrene particles, polypropylene microspheres, mineral powders such as talc, iron carbonate and calcium carbonate, chitosan particles and flame retardant minerals, such as calcium carbonate, aluminum hydroxide, magnesium hydroxide and various borates and inorganic hydrates. Also, which may be added to the chemical treatment mixture to enhance super-hydrophobicity, are chlorinated or fluorinated silicone compounds such as heptadecafluorodecyltrimethoxysilane, octadecyldimethylchlorosilane, tris(trimethylsiloxy)silylethyldimethylchlorosilane, octyldimethylchlorosilane, dimethyldichlorosilane, butyldimethylchlorosilane, trimethylchlorosilane, or mixtures of any two or more thereof; Note that some additives to the chemical treatment mixture may provide more than one property as specified herein.

e) antimicrobial treatments, i.e., substances that inhibit microbial growth and/or kill microorganisms. These include, for example, silver or copper nano- or micro-particles; iodine compounds including providone iodine; triclosan and other quaternary ammonium chlorides such as benzalkonium chloride, cetyl trimethylammonium, or benzethonium chloride; chlorhexidine gluconate, octenidine dihydrochloride, glutaraldehyde, chitosan, terpenes such as tea tree oil or pine oil; lysozyme, citrus oils, titanium dioxide and the like;

f) UV absorbers and/or UV reflecters such as avobenzone, rutile titanium dioxide, silicon dioxide, homosalate, oxybenzone, 4-aminobenzoic acid (PABA), octisalate, octocylene, 2-ethylhexyl 4-dimethylaminobenzoate and the like;

g) Colorants such as dyes and pigments. These include acid dyes, which are useful with protein-based fibers such as wool and silk, as well as nylon; reactive dyes, which are useful for natural cellulosic fibers such as cotton, linen, hemp and the like; and disperse dyes, which are useful for coloring various synthetic fibers and synthetic/cotton blends. The colorant may be capable of forming a chemical bond to the substrate or the polymerized monomer(s), thereby providing colorfastness and laundry durability. This approach to fabric dyeing can eliminate a major cause of water pollution around textile manufacturing and finishing facilities because there is less waste of dye chemicals;

h) Wrinkle-resisting agents, such as melamine-formaldehyde resins and urea-formaldehyde resins;

i) fabric softeners and anti-chafing agents, such as polydimethylsiloxane and polymethylhydrosilane;

j) Light and/or heat-reflecting materials such as reflective metal particles, titanium dioxide or ZnO particles and the like;

k) Cross-linking agents, which crosslink the various polymers formed during the curing step, or crosslink a finishing attribute to such a polymer and/or to the substrate. These include, for example, 1,3-dienes such as 1,4-polyisoprene, 1,3-butadine, ethylene-propene-diene terpolymer (EPDM), dipentaerythritol penta-/hexaacrylate, diisocyanates, “blocked” isocyanates, diepoxides, diacrylates, such as 1,6-hexanediol diacrylate, other diacrylate and triacrylate compounds;

l) Emollients which create, for example, softness, wear comfort and/or moisturizing properties. These include, for example, aloe vera oil, tea tree oil, coconut oil, almond oil, citrus oil, vitamin E, decamethylcyclopentasiloxane and various polymerized silicones and siloxanes;

m) Insecticides and/or insect repellants, such as metofluthrin, transluthrin, dichlovos, thyme oil, rosemary oil, citronella oil, cinnamon bark oil, lemon eucalyptus oil, lemongrass oil, and cedar wood oil;

n) Plasticizers such as bis(2-ethylhexyl phthalate (“DEHP”), diisononyl phthalate (“DINP”), di-n-butyl phthalate (“DnBP”), butyl benzyl phthalate (“BBzP”), diisodecyl phthalate (“DIDP”), diisodecyl phthalate (“DIDP”), di-n-octyl phthalate (“DOP”), diisooctyl phthalate (“DIOP”), diethyl phthalate (“DEP”), diisobutyl phthalate (“DIBP”), di-n-hexyl phthalate, trimethyl trimellitate (“TMTM”), tri-(2-ethylhexyl trimellitate (“TEHTM-MG”), tri-(n-octyl, n-decyl) trimellitate (“ATM”), tri-(heptyl, nonyl) trimellitate (“LTM”), n-octyl trimellitate (“OTM”), bis(2-ethylhexyl) adipate (“DEHA”), dimethyl adipate (“DMAD”), monomethyl adipate (“MMAD”), “dioctyl adipate (“DOA”), dibutyl sebacate (“DBS”), dibutyl maleate (“DBM”), diisobutyl maleate (“DIBM”), various benzoates, terephthalates, epoxidized vegetable oils, 1,2-cyclohexane dicarboxylic acid diisononyl ester, sulfonamides, organophosphates, glycols/polyethers, polymerized silicone oils, alkyl citrates, acetylated monogylcerides, all added in the amount of 2-40% by weight, if present.

o) Abrasive fine particles, such as titanium carbide, tungsten carbide, pumice, Borazon, silicon carbide, zirconia alumina, and the like, which may be added to the chemical treatment mixture to provide added puncture protection against shrapnel, knife and bayonets in body armor fabric. These act by causing a sharp object to become increasingly dulled as the object penetrates through progressive layers of aramid fabric. The polymer causes the abrasive fine particles to be “locked” in place between woven yarn for this purpose.

p) Additives for flame retardancy, such as the previously mentioned flame retardant minerals and various organophosphorous and boron-containing compounds.

The chemical treatment mixture may contain one or more other materials such as, for example, free radical initiators, promoters and the like as may be necessary or desirable to effect the polymerization step.

The free radical initiator preferably is heat activated at a temperature higher than the melting or softening temperature of the chemical treatment mixture. Suitable free radical initiators include, for example, 1) acyl peroxides, such as acetyl or benzoyl peroxides, 2) alkyl peroxides, such as cumyl, dicumyl, lauryl, or t-butyl peroxides as well as other water-soluble peroxides, 3) hydroperoxides, such as t-butyl or cumyl hydroperoxides, 4) peresters, such t-butyl perbenzoate, 5) other organic peroxides, including acyl alkylsulfonyl peroxides, dialkyl peroxydicarbonates, diperoxyketals, or ketone peroxides, 6) azo compounds, such as 2,2′-azobisisobutyronitrile (AIBN) or 2,2′-azobis(2,4-dimethylpentanenitrile), 4,4′-azobis(4-cyanovaleric acid), or 1,1′-azobis (cyclohexanecarbonitrile), or 7) various tetrazines. Free radical initiators that are solids at 25° C. are preferred, as are those having a 10 hour half-life at a temperature of 60° C. or higher. Liquid free radical initiators and those having less than 10 hour half-life temperatures tend to cause the solid chemical treatment mixture to be less stable due to the premature generation of free radicals and consequent polymerization of the monomer(s) during storage, shipping and at other times before application to the substrate. Lauroyl peroxide is a preferred chemical initiator because it is stable for extended periods at temperatures below 90° C., which means it can be mixed into the melt of the chemical treatment mixture without triggering polymerization, provided that the melt and casting of the chemical treatment mixture to form a solid phase is quickly accomplished at temperatures less than ˜80° C. Additionally, benzoyl peroxide, which is insoluble in water, may dissolve in certain nonpolar melts used in some of the solid chemical formulations and so can provide an effective, heat-activated free radical polymerization process.

The chemical treatment mixture may also include one or more promoters or activators for a polymerization catalyst and/or free radical initiator. Metal salts such as iron or vanadium salts and manganese ions or manganese are examples of such promoters. These inorganic salts may be added to the solid chemical treatment mixture used for substrate finishing even if the inorganic salt is insoluble in the melt of the chemical treatment mixture prior to casting. The inorganic salts become embedded in the solid phase of the chemical treatment mixture, 3, but are transferred to substrate 1, and become active, chemical reactants during the subsequent polymerization step.

The solid chemical treatment mixture can be prepared by combining the carrier or mixture of carriers with the monomer(s), finishing attribute chemical(s) (if any) and other materials (if any) at a temperature above the melting or softening temperature of the carrier materials. The order of addition typically is not critical. Conditions need to be selected to prevent the monomer(s) from polymerizing during preparation of the chemical treatment mixture, and to prevent any other unwanted chemical reactions. After the chemicals are combined, they can be stirred or mixed for a period of time at a temperature above the melting or softening temperature, to uniformly distribute the various substances into the carrier or mixture of carriers. The monomer(s), finishing attribute chemical(s) and other ingredients will, in some cases, dissolve in the carrier or mixture of carriers. In other cases, some or all of those materials may not dissolve, but instead become dispersed in the carrier or mixture of carriers, in which case the carrier or mixture of carriers forms a continuous phase in which the other undissolved materials form a stable, disperse phase. Such a disperse phase may be liquid or solid.

After mixing the materials, the mixture is cooled, or is allowed to cool to below its melting or softening temperature to solidify it. Typically this is done by cooling the mixture in a mold or cast, so the solidified material has a shape and dimensions suitable for the intended application and for ease of application. It may be helpful to line the walls of the mold or cast with a non-absorbent, easy-release film such as PTFE or other non-wetting material to facilitate removal. When the mixture has cooled to room temperature, the solidified mixture is simply removed from its cast and is ready for packaging, labeling, shipment and use with the appropriate application hardware. It is often convenient to package the cast mixture with a nonporous wrapping or other container. This simplifies handling of the solidified mixture during shipping and storage and for dimensional integrity.

The chemical treatment mixture is a solid at 20° C., which has a melting or softening temperature of at least 30° C. up to 100° C. A preferred softening temperature is 40 to 80° C. and a more preferred softening temperature is 40 to 60° C. For purposes of this invention, “melting temperature” and “softening temperature” are used interchangeably to refer to a temperature at which at least some of the chemical treatment mixture, preferably the carrier material(s), transitions from a solid to a fluid; this temperature is not necessarily a crystalline melting temperature. In some embodiments, the chemical treatment mixture exhibits a broad softening or melting temperature, so that upon softening it does not exhibit a sharp viscosity decrease to become a low viscosity fluid.

It is further noted that not all of the components of the chemical treatment mixture need to become melted or softened provided that any unmelted or unsoftened materials remain dispersed in the molten or softened portion of the mixture and are borne with it through the application and polymerization process.

The softened or melted portion of the chemical treatment mixture preferably forms a high (>500 cps, preferably at least 2000 cps) viscosity fluid at the temperature at which it is transferred to the substrate. The viscosity may be as 50,000 cps or even more at such temperature. Such higher viscosity materials are resistant to dripping, splashing and running off the substrate, and also better entrain solid components that are not melted during the application process.

It is noted that the softening temperature of the chemical treatment mixture as a whole may be different than that of the carrier or mixture of carriers or that of the other chemical treatment ingredients. This is due in some cases to the melting temperature depression phenomenon, which occurs when one or more of the other components of the mixture, such as the polymer precursor(s), finishing attribute chemical(s), colorants, and the like, are soluble in the carrier or mixture of carriers. This melting temperature depression is an advantage of the invention, as it often permits the mixture to be heat-softened at lower temperatures than would otherwise happen for some of its components if neat. This allows the substrate to be coated at lower temperatures than would otherwise be needed if only pure chemicals were individually applied to the substrate. It also allows the chemical treatment mixture to be heat-softened and spread onto the fabric at temperatures below that at which the monomers polymerize. This facilitates separation of the application and polymerization steps, yielding better control of the process and more uniform spreading of the chemical treatment mixture as it is applied. This is important because polymerization prevents the mixture from being uniformly spread across the substrate. Similarly, the phenomenon of boiling point elevation in some embodiments helps to reduce the evaporation and loss of volatile components of the solid chemical treatment mixture during the application and polymerization steps of the inventive process. This is contrasted with the conventional, wet-based, “pad and cure” method of FIG. 1, which essentially contributes to the loss of finishing chemicals by steam distillation due to the boiling off of water from the wet, chemically-treated fabric. Because of this, the present invention is also more efficient in chemical use than current wet processes.

Protective encapsulation of certain chemicals may be used in the chemical treatment mixture to help prevent premature reaction with other chemical components. The encapsulated chemicals may be released from encapsulation and allowed to chemically react with the other components in the film that is applied to the substrate, 1, mechanically (such as, in the embodiment shown in FIG. 2), due to rupture of the microcapsules from the pressure applied by the nip rollers, 6 and 7), thermally, or otherwise.

The solid chemical treatment mixture is preferably provided to the process in the form of a non-particulate solid. By “non-particulate”, it is meant that the solid chemical treatment mixture is in the form of a single piece, or if in the form of multiple pieces, at least 90% of the mass of the solid chemical treatment mixture is in the form of one or more large pieces each having a volume of at least 100 mL, preferably at least 500 mL. Preferably, each chemical applicator means contains a single, large piece of the solid chemical treatment mixture and, in the inventive process, the chemical treatment mixture remains in solid form as it is brought proximate to (such as within 2 meters of, preferably within 1 meter of) the substrate. In this process (including embodiments that involve a chemical spray), this step is preferably performed immediately (such as within 30 seconds, preferably within 5 seconds) before the chemical treatment mixture is applied to the substrate and in close proximity (such as within 2 meters of, preferably within 0.5 meters) to the substrate.

The following examples are intended to illustrate the invention but not to limit the scope thereof. All parts and percentages are by weight unless otherwise indicated.

### EXAMPLE 1

A simple, non-fluorocarbon, solid chemical treatment mixture for hydrophobicity is formulated using 10.056 g of 1-octadecanol, 19.83 g of stearyl acrylate plus 4.35 g of benzoyl peroxide, producing, when cooled to room temperature, a solid mixture that is heat-softened and easily spread across a 100% cotton duck substrate using light, uniform pressure. This chemical treatment mixture is applied to both sides of the substrate. This treated sample is then baked for 6 minutes at 148° C. The treated fabric sample has no detectable difference in the “hand” from an untreated sample of the same fabric; however it is clearly hydrophobic and produces a contact angle of ˜130° when a drop of water is placed on the cotton sample, indicating super-hydrophobicity. The untreated sample wicks water immediately. There is no visible change in the appearance or odor of the treated sample. The treated sample is found to be laundry-durable, maintaining its hydrophobic nature.

### EXAMPLE 2

An antimicrobial, hydrophobic, and oleophobic chemical stick is formulated using 8.32 g of 1-octadecanol, 11.02 g of octadecyl acrylate, 2 g of finely-divided chitosan powder, 0.8 mL of lauryl acrylate, 4 mL of 2-(perfluorohexyl) ethyl acrylate, and 1 mL of 1,6-hexanediol diacrylate, plus 4.0 g of benzoyl peroxide. This chemical stick is harder than the one of in Example 1. It is heat-softened and applied to both sides of a 100% heavy cotton duck substrate and both sides of a lighter, 100% woven cotton substrate. The coated samples are heat treated for 6 minutes at 160° C. to cure the treatment and the resultant cured substrates are found to be both water repellent and oil repellent. Then, 1 mL of milk is applied to each of the treated samples and an equivalent set of untreated samples. The milk wicks into the untreated samples. On the treated samples, it is necessary to physically push the milk into the fabric. The samples with milk applied to them are kept at room temperature and were left open to air for 4 days. At the end of 4 days, the untreated samples smell badly whereas the treated samples have no detectable odor, demonstrating an antimicrobial treatment.

### EXAMPLE 3

A solid chemical treatment mixture intended to produce an oleophobic and super-hydrophobic finishing treatment is prepared by mixing 7.385 g 1-octadecanol, 13.983 octadecyl acrylate, 1.0 mL of lauryl acrylate, 4 mL 2-(perfluorohexyl) ethyl acrylate, 2 mL of 1,6-hexanediol diacrylate, 9.6 mL of decamethylcyclopentasilaxane and 0.862 g of silica gel 60. These chemicals are heated to 80° C. All dissolve easily except the silica gel, which imparts a cloudy appearance to the solution. The mixture is then allowed to partially cool and 5.48 g benzoyl peroxide is added to the mixture as it cools to 50° C. The mixture is then allowed to cool further until it hardens and is constantly stirred until it hardens. This solid chemical treatment mixture is heat softened, coated onto one or both sides of cotton and polyester samples and cured by heat at 160° C. for 6 minutes. Treated samples exhibit a high degree of water and oil repellency and a water droplet contact angle that is >120 degrees.

### EXAMPLE 4

Another solid, water repellent chemical treatment mixture is prepared by mixing 16.689 g 1-octadecanol, 12.471 g octadecyl acrylate, 5 mL 2-(perfluorohexyl) ethyl acrylate, 4 mL 1,6-hexanediol diacrylate and 5.6 mL decamethylcyclopentasiloxane as a base mixture. This base mixture is fully dissolved by heating to 80° C. and stirring, and then is split into 4 different aliquots. Stick A is made by mixing 11.73 of the above base mixture with 1.289 g of benzoyl peroxide added when cooled. Stick B is made by mixing 11.629 of the base mixture and 2.315 g of benzoyl peroxide. Stick C is made by mixing 11.359 of the base mixture, 0.762 g of silica gel 60 and 1.256 g of benzoyl peroxide. Stick D is made by mixing 6.600 g of the base mixture, 0.443 g of orcocilacron navy S2GL disperse dye and 0.709 g of benzoyl peroxide.

Cotton and polyester samples are treated with all of sticks A-D by heat-softening the sticks and applying the heat-softened material to the fabric samples. The best water repellency is observed for polyester samples treated on both sides with stick C, followed next by polyester and cotton samples treated with stick B. Samples treated with stick A are hydrophobic, but are less hydrophobic than samples treated using sticks B or C. Polyester samples treated with stick D are successfully dyed and are repellent to water. Greige, para-aramid samples (still containing sizing in them) are treated on both sides with stick B and show excellent water repellency and have only 8.9% water absorption after being exposed to a continuous water spray of 6 l/min over a 10 minute timeframe.

### EXAMPLE 5

A non-water repellent chemical stick for dye application is prepared by mixing 6.362 g of 1-octadecanol, 5.3 mL of decamethylcyclopentasiloxane and 0.291 g of disperse dye orcocilacron navy S2GL. This mixture is allowed to cool and is used to coat a sample of 100% polyester as in previous examples. The sample is then baked at 165° C. for 6 minutes. The treated and cured polyester sample is dyed and colorfast and remains hydrophilic.

### EXAMPLE 6

A mixed monomer, water repellency chemical treatment for greige polyaramid fabric is prepared by mixing a “base” formulation consisting of 27.722 g of octadecyl acrylate, 6 mL of 2-(perfluorohexyl) ethyl acrylate, 4 mL of 1,6 hexanediol diacrylate, and 2 mL of lauryl acrylate. This mixture of solid and liquid chemicals is heated to about 80° C. to dissolve and mix all base components. Then, the mixture is allowed to slightly cool and 8 mL of decamethylcyclopentasiloxane is added. The mixture is still liquid. This mixture is split into 3 aliquots to make 3 different chemical treatment sticks.

Stick A has 13.927 g of the base mixture with 6.382 g of octadecanol added to make a thick paste. Then, 0.361 g of benzoyl peroxide is added to the paste and the mixture is cast into a solid stick.

Stick B has 11.898 g of the base mixture with 3.459 g of octadecanol added. It remains a syrupy liquid. When 0.371 g of benzoyl peroxide is added, it becomes a thick paste which is allowed to cool as it is cast into a solid stick.

Stick C has 13.956 g of the base mixture with 4.007 g of octadecanol added, to make a paste. Then, 1.682 g of benzoyl peroxide is added to the paste and the paste is cast into a solid stick.

Three 6.5″×6.5″ samples of greige, para-aramid ballistic protection fabric are treated on both sides with each of the three above chemical sticks, by heat softening the sticks and transferring the heat softened material to the samples. The coating flows easily from the chemical applicator onto the samples without the need for added heat and is spread with a roller using gentle pressure. Greige para-aramid fabric is much harder to make waterproof than de-sized fabric because the sizing agent is left in the yarn. The sizing agent is known to interfere with wet methods for waterproofing and polymerization and so cannot currently be easily treated using conventional wet processing methods.

The three treated samples are baked at 165° C. for 6 minutes, trimmed, placed on an embroidery hoop and then are spray tested using a constant spray of cold water flowing at 6 l/min for 10 minutes. At the end of the spray test, the samples are removed from the hoop, spun to remove standing water, and are weighed to measure absorbed water.

Sample A shows a 10.3% weight gain, Sample B shows a 14.2% weight gain, and sample C shows a 10.6% weight gain following the spray test. Less effective treatments often show as much as 50-75%% weight gain from this kind of finishing process and spray test. The results show that the amount of chemical initiator added has little effect on the effectiveness of the treatment, provided that the minimum amount of initiator is present.

### EXAMPLE 7

To compare the effectiveness of the mixed fluorocarbon/hydrocarbon monomers and crosslinkers used in Example 6 with hydrocarbon-based monomers, in this example, only hydrocarbon-based monomers, crosslinkers and thermal initiators are used. A chemical stick is prepared by mixing 16.349 g of octadecyl acrylate, 2 mL of lauryl acrylate, 2 mL of 1,6 hexanediol acrylate and 1.986 g of 1-octadecanol. When heated, a clear solution is formed and is easily mixed. This mixture has slowly solidifies. The mixture is cast into a mold and solidified at room temperature in about 24 hours.

A 6.5″×6.5″ sample of greige para-aramid fabric is easily coated with the heat-softened chemical stick and applicator on both sides of the fabric using only minimal pressure on the sample. This sample is thermally cured at 165° C. heat for 6 minutes and is then spray tested in the manner described in Example 6. The measured weight gain from water pickup is only 6.1%, demonstrating the effectiveness of the pure hydrocarbon chemistry composition.

### EXAMPLE 8

For a laundry-durable, super-hydrophobic chemical treatment applied to polyester fleece, a chemical treatment mixture is prepared consisting of 11.4 g 1-octadecyl acrylate, 1.3 g stearyl methacrylate, 2.6 g 1,6 hexanediol diacrylate, 2.3 g lauryl acrylate, 6.7 g paraffin wax, 1.1 g dipentaerythrital penta-/hexa acrylate, and 1.8 g linseed oil. This mixture is heated to dissolve all components and uniformly mixed. When cooled, 1.5 g of lauroyl peroxide is added and dissolved into the mixture. The mixture is cooled further and cast into a mold to form a uniform-phase, solid chemical treatment stick. This mixture is melted onto a textured, heated metal plate (50° C.). The melt is then transferred onto paper by pressing the paper against the coated plate. The mixture solidifies on the transfer paper. The coated transfer paper is placed on one side of a 100% polyester fleece fabric and the chemical treatment mixture is transferred to the fleece using a commercial, iron steam press. The treated fleece is next heat-cured for 6 minutes at 124° C. The product exhibits super-hydrophobic properties with a water droplet contact angle of about 150°, without affecting the color, hand or other properties of the fabric. Super-hydrophobic properties are observed only on the fabric side that is treated. Laundry durability testing shows that this treatment maintains its super-hydrophobic properties for at least 75 laundry cycles. AATCC 22 spray test results show spray ratings of 100 for all samples for at least 50 cycles and for at least 75 laundry cycles in 3 out of 4 samples. Additional testing indicates that curing of fabric treated in this manner could be done as long as two weeks after chemical treatment transfer to the fabric without deleterious effects.

### EXAMPLE 9

To demonstrate the use of the invention with curing by plasma, UV light or ionizing radiation, a chemical treatment mixture is prepared similar to that described in Example 8 but without using the thermal polymerization initiator, lauroyl peroxide. Samples of 90% polyester/10% Lycra fabric are treated using the method described in Example 8. The treated, but not cured, fabric samples exhibit some hydrophobicity, but have poor AATCC spray test performance and poor laundry durability. The treated poly/Lycra samples that are exposed to an atmospheric pressure, dielectric barrier plasma for 2-3 seconds operating on nitrogen gas exhibit excellent AATCC 22 spray test results and have excellent laundry durability. The timing delay between applying the chemical treatment on the fabric and the plasma curing is about 2.5 weeks.

Further specific embodiments of the invention include:

A. A method for continuously applying a chemical treatment to a substrate, comprising

a) positioning one or more pieces of a non-particulate, solid chemical mixture having a softening temperature of at least 30° C. proximate to or in physical contact with a surface of the substrate;
b) continuously passing a width of substrate past the positioned piece or pieces of non-particulate chemical mixture and applying the chemical treatment from the non-particulate chemical mixture across at least 80% of the width of at least one surface of the substrate.

B. A method for applying a chemical treatment to a substrate, comprising

a) providing one or more pieces of a solid chemical treatment mixture having a softening temperature of 30° C. to 100° C. and containing at least one monomer that polymerizes in a free radical polymerization;
b) heat-softening the chemical treatment mixture and supplying the heat-softened chemical treatment mixture to a transfer apparatus without significantly polymerizing the chemical treatment mixture;
c) passing a width of a fibrous substrate into contact with the transfer apparatus and transferring the heat-softened chemical treatment mixture from the transfer apparatus to the fibrous substrate; and then
d) polymerizing the monomer in the chemical treatment mixture on the fibrous substrate in a free-radical polymerization.

C. The method of B wherein at least step c) is performed continuously.

D. B or C, wherein the chemical treatment mixture is cooled below its melting or solidification temperature prior to step d).

E. Any of B-D, wherein the solid chemical treatment mixture provided in step a) is non-particulate.

F. Any of B-E, wherein steps b) and c) are performed by softening the solid chemical treatment mixture by applying the solid chemical treatment mixture to a heated application roller or rollers in contact with the substrate, which heated application roller transfers the chemical treatment mixture to the substrate.

G. The method of E, wherein the solid chemical treatment mixture is held against the heated application roller or rollers with a mounting and tensioning apparatus.

H. Any of B-G wherein in step c), the melted or softened chemical treatment mixture is applied across at least 80% of the width of at least one surface of the substrate.

I. Any of B-H, wherein the solid chemical treatment mixture is melted or softened within 30 seconds, or preferably within 5 seconds, of applying it to the substrate, and remains in the melted or softened state until it is applied to the substrate.

J. Any of B-I, wherein the solid chemical treatment mixture or a portion thereof melts or softens to form a high (>500 cps, preferably at least 2000 cps) viscosity fluid at the temperature at which the chemical treatment mixture is transferred to the substrate. The viscosity may be as 50,000 cps or even more at such temperature.

K. A method for applying a chemical treatment to a substrate, comprising

a) providing a transfer sheet including a sheet material impregnated or coated with a solid (at 20° C.) chemical treatment mixture having a softening temperature of 30° C. to 100° C. and containing at least one monomer that polymerizes in a free radical polymerization;
b) contacting the transfer sheet to a fibrous substrate and heating the transfer sheet in contact with the fibrous substrate to heat-soften the chemical treatment mixture and transfer at least a portion of the heat-softened chemical treatment mixture from the transfer sheet to the substrate without polymerizing the chemical treatment mixture;
c) polymerizing the monomer in the solidified chemical treatment on the fibrous substrate in a free-radical polymerization.

L. The method of K wherein the chemical treatment mixture is cooled below its melting or solidification temperature prior to step c).

M. Any of K or L wherein the transfer sheet is paper; a woven, knitted, entangled or non-woven fabric; cardboard; a polymer film; or a metal foil.

N. Any of K, L or M wherein at least step b) is performed continuously.

O. Any of K-N wherein the transfer sheet is continuously impregnated or coated with the chemical treatment mixture.

P. Any of K-O wherein the transfer sheet is coated or impregnated by softening the solid chemical treatment mixture by applying the solid chemical treatment mixture to a heated application roller or rollers in contact with the transfer sheet, which heated application roller transfers the chemical treatment mixture to the transfer sheet.

Q. Any of B-P wherein the polymerization step is performed by exposing the monomer(s) to a source of free radicals. The step of exposing the monomer(s) to a source of free radicals includes one or more of (i) heating a chemical treatment mixture which contains a heat-activated free-radical initiator to a temperature at which the free radical initiator generates free radicals; (ii) contacting the treated substrate with a plasma, (iii) exposing the treated substrate to ultraviolet radiation, e-beam radiation or other ionizing radiation source with produces free radicals or (iv) subsequently contacting the treated substrate with an additional component, not present in the chemical treatment mixture, which provides or generates free radicals.

R. Any of B to Q, wherein the substrate is a woven, knitted, entangled, knotted, felted, or glued fabric in the form of a sheet having a thickness of no greater than 12 mm, and a width of at least 100 mm.

S. Any of B-R, wherein the substrate with applied chemical treatment mixture is also contacted with a mist, vapor or spray.

T. Any of B-S, wherein the coating weight of the chemical treatment mixture is 1 to 70 g/m³, 2 to 50 g/m³ or 3 to 25 g/m³.

U. Any of B-T, wherein the substrate is one or more of (i) flexible, (ii) in the form of a sheet having a thickness of no greater than about 12 mm, no more than 8 mm or no more than 4 mm, and a width of at least 100 mm, at least 300 mm or at least 600 mm or (iii) a woven, knitted or non-woven fabric.

V. A solid chemical treatment mixture having a softening temperature of 30° C. to 100° C. comprising at least one monomer that polymerizes by free radical polymerization and a carrier or mixture of carriers in which the monomer(s) are dispersed or dissolved.

W. Any of B-V, wherein the chemical treatment mixture includes one or more of (i) a carrier or mixture of carriers in which the monomer(s) are dispersed or dissolved, (ii) at least one finishing attribute compound and (iii) at least one heat-activated free radical initiator.

X. Any of B-W, wherein the monomer(s) include at least one monomer having at least one polymerizable acrylate or methacrylate group.

Y. Any of B-X, wherein the polymerization step is performed continuously by continuously transporting the treated substrate past or through a free radical polymerization zone.

Z. Any of B-Y wherein at least one monomer contains at least one acrylate or methacrylate functional group. In any such case, the monomer may be an alkyl acrylate or alkyl methacrylate in which the alkyl group contains 6 to 24 carbon atoms and wherein the alkyl group may contain one or more fluorine atoms and/or the monomer may be fluorinated.

AA. Any of B-Z, wherein the carrier or mixture of carriers includes one or more of an aliphatic monoalcohol having 14 to 30 carbon atoms; an ester of a fatty acid and a fatty alcohol; a polyether having one or more hydroxyl groups; a polysiloxane; a polysilane-poly(alkylene glycol) copolymer; glycerin, sorbitol, xylitol, a wax, or a fluoropolymer.

AB. Any of B-AA, wherein the chemical treatment mixture includes solid particles having a fine particle size from 50 nm to 100 microns dispersed in the carrier or mixture of carriers. In any such case, the solid particles may be particles of a fluorinated alkene polymer, an inorganic metal salt, silica gel, fumed silica, glass, polystyrene, chitosan, a flame retardant mineral, an abrasive or mixtures of any two or more thereof.

AC. Any of B-AB, wherein the chemical treatment mixture contains at least one colorant and a carrier or mixture of carriers in which the colorant is dispersed or dissolved.

AD. Any of B-AC, wherein the chemical treatment mixture contains no more than 5% water by weight.

AE. Any of W-AD, wherein the finishing attribute chemical includes one or more of a colorant, a water-repellant, a oil repellant, wrinkle-resistant finishing agent, a stain repellant, an antimicrobial, a flame retardant additive, an antifungal agent, a UV absorber, an insect repellant, a wicking finish, an adhesion promoter, a fragrance, an emollient, a softening agent or a forensic chemical marker.

AF. An apparatus for applying a solid chemical treatment mixture to a width of substrate, comprising

a) transporting means for holding a substrate and continuously transporting the substrate past and into contact with a chemical transfer apparatus and through a free-radical polymerization zone and

b) a chemical transfer apparatus for heat-softening a solid chemical treatment mixture and transferring the heat-softened chemical treatment mixture across at least 80% of the width of at least one surface of the substrate as the substrate is transported past and in contact with the chemical transfer apparatus to produce a treated substrate;

c) a free-radical polymerization zone downstream of the chemical transfer apparatus.

AG. The apparatus of AF, wherein the chemical transfer apparatus is adapted to apply the chemical treatment mixture across at least 80% of the width of the substrate.

AH. The apparatus of AF or AG, wherein the chemical transfer apparatus comprises a heated application roller that spans at least 80% of the width of the substrate and is in contact with the substrate, and which transfers the solid chemical treatment mixture to at least one surface of the substrate, and means for supplying the chemical treatment mixture to the surface of the heated application roller.

AI. The apparatus of any of AF, AG or AH, further comprising a support that holds the substrate against the chemical transfer apparatus with a controllable tension. Such a support may include a roller, and the apparatus may further comprise means for heating the roller. In any of these cases, the roller may be driven and form at least a portion of the transporting means.

AJ. Any of AF-AI, further comprising heating means for heating and softening chemical treatment mixture on the treated substrate. The heating means may include a roller in contact with the treated substrate, and means for heating the roller.

AK. Any of AF-AJ, further comprising means for applying a liquid spray to the substrate prior to transferring the chemical treatment mixture to a surface of the substrate or to the coated substrate, or both, and the transport means is adapted to also continuously transport the substrate past the means for applying the liquid spray.

AL. Any of AF to AK, wherein the transport means includes at least one drive roller, a tenter frame or at least one winding apparatus located downstream of the chemical transfer apparatus.

AM. Any of AF to AL which includes at least two chemical transfer apparatuses in series.

AN. Any of AF to AM, wherein the free radical polymerization zone includes one or more of a heat source for heating the chemical treatment mixture to a temperature at which a free radical initiator in the chemical treatment mixture generates free radicals; (ii) means for contacting the treated substrate with a plasma (such as a plasma generator and optionally means for bringing the treated substrate into contact with the generated plasma), (iii) means for exposing the treated substrate to ultraviolet radiation, e-beam radiation or other ionizing radiation source with produces free radicals (such as sources for such radiation source and means for directing such radiation source onto the treated substrate) or (iv) means for contacting the treated substrate with an additional component, not present in the chemical treatment mixture, which provides or generates free radicals (such as one or more chemical applicator devices for applying solid, liquid or gaseous materials with the substrate).

1. A method for applying a chemical treatment to a fibrous substrate, comprising
a) providing one or more pieces of a solid chemical treatment mixture having a softening temperature of 30° C. to 100° C. and containing at least one monomer that polymerizes in a free radical polymerization;
b) heat-softening the chemical treatment mixture and supplying the heat-softened chemical treatment mixture to a transfer apparatus without significantly polymerizing the chemical treatment mixture;
c) passing a width of the substrate into contact with the transfer apparatus and transferring the heat-softened chemical treatment mixture from the transfer apparatus to the fibrous substrate; and then
d) polymerizing at least one monomer in the chemical treatment mixture on the fibrous substrate in a free-radical polymerization.

2. The method of claim 1 wherein at least step c) is performed continuously.

3. The method of claim 1 wherein the chemical treatment mixture is allowed to cool below its melting or solidification temperature prior to step d).

4. The method of claim 1, wherein the solid chemical treatment mixture provided in step a) is non-particulate.

5. The method of claim 1, wherein steps b) and c) are performed by softening the solid chemical treatment mixture by applying the solid chemical treatment mixture to a heated application roller or rollers in contact with the substrate, which heated application roller transfers the chemical treatment mixture to the substrate.

6. The method of claim 1 wherein in step c), the melted or softened chemical treatment mixture is applied across at least 80% of the width of at least one surface of the substrate.

7. A method for applying a chemical treatment to a substrate, comprising
a) providing a transfer sheet including a sheet material impregnated or coated with a solid chemical treatment mixture having a softening temperature of 30° C. to 100° C. and containing at least one monomer that polymerizes in a free radical polymerization;
b) contacting the transfer sheet to a fibrous substrate and heating the transfer sheet in contact with the fibrous substrate to heat-soften the chemical treatment mixture and transfer at least a portion of the heat-softened chemical treatment mixture from the transfer sheet to the substrate without significantly polymerizing the chemical treatment mixture;
c) polymerizing the monomer in the solidified chemical treatment on the fibrous substrate in a free-radical polymerization.

8. The method of claim 7 wherein the chemical treatment mixture is cooled below its melting or solidification temperature prior to step c).

9. The method of claim 7 wherein the transfer sheet is paper; a woven, knitted, entangled or non-woven fabric; cardboard; a polymer film; or a metal foil.

10. The method of claim 7 wherein the substrate is a piece of apparel, a home furnishing fabric, a hospitality fabric, or an individual technical textile item.

11. The method of claim 1 wherein the polymerization step is performed by exposing the monomer(s) to a source of free radicals.

12. The method of claim 11 wherein the step of exposing the monomer(s) to a source of free radicals includes one or more of (i) heating a chemical treatment mixture which contains a heat-activated free-radical initiator to a temperature at which the free radical initiator generates free radicals; (ii) contacting the treated substrate with a plasma, (iii) exposing the treated substrate to ultraviolet radiation, e-beam radiation or other ionizing radiation source to produce free radicals or (iv) contacting the treated substrate with an additional component, not present in the chemical treatment mixture, which provides or generates free radicals.

13. The method of claim 1, wherein the substrate is a woven, knitted, entangled, knotted, felted, or glued fabric in the form of a sheet having a thickness of no greater than 12 mm, and a width of at least 100 mm.

14. The method of claim 1, wherein the chemical treatment mixture includes a carrier or mixture of carriers in which the monomer(s) are dispersed or dissolved.

15. The method of claim 1, wherein the chemical treatment mixture further contains at least one finishing attribute chemical.

16. The method of claim 1, wherein the chemical treatment mixture further contains at least one heat-activated, free radical polymerization initiator.

17. The method of claim 1, wherein the monomer(s) include at least one monomer having at least one polymerizable acrylate or methacrylate group.

18. The method of claim 1, wherein the polymerization step is performed continuously by continuously transporting the treated substrate past or through a free radical polymerization zone.

19. An apparatus for applying a chemical treatment mixture to a width of substrate, comprising
a) transporting means for holding a substrate and continuously transporting the substrate past and into contact with a chemical transfer apparatus and through a free-radical polymerization zone and
b) a chemical transfer apparatus for heat-softening a solid chemical treatment mixture and transferring the heat-softened chemical treatment mixture to the substrate and transferring the heat-softened chemical treatment mixture across at least 80% of the width of at least one surface of the substrate as the substrate is transported past and in contact with the chemical transfer apparatus to produce a coated substrate;
c) a free-radical polymerization zone downstream of the chemical transfer apparatus.

20-21. (canceled)
